(19) United States
(12) Patent Application Publication
(10) Pub. No.: US 2005/0104338 A1
(43) Pub. Date: May 19, 2005

(54) Applique film airbag cover

(76) Inventor: Quin Soderquist, South Weber, UT (US)

Correspondence Address: Sally J. Brown;AUTOLIV ASP, INC., 3350 Airport Road, Ogden, UT, 84405, US

(21) Appl. No.: 10/717,851

(22) Filed: Nov. 19, 2003

(51) Int. Cl. B60R 21/20

(52) U.S. Cl. 280/728.3

(57) ABSTRACT

The applique film airbag cover includes a substrate and an applique film. The substrate includes a tear seam to permit the emergence of a contained inflatable cushion. The applique film is disposed on an exposed surface of the substrate and is disposed across at least one tear seam in the substrate. The substrate may include contours that can be aligned with an emblem design on the applique film to produce a three-dimensional emblem. In response to expansion of the contained cushion, the tear seam and applique film rupture to permit the cushion to emerge through the cover.

### BACKGROUND OF THE INVENTION

1. Field of the Invention

The present invention relates to covers for airbags. More specifically, this invention relates to a cosmetic airbag cover that includes an applique film.

2. Description of Related Art

Inflatable airbags are well accepted for use in motor vehicles and have been credited with preventing numerous deaths and injuries. Some statistics estimate that frontal airbags reduce the fatalities in head-on collisions by 25% among drivers using seat belts and by more than 30% among unbelted drivers. Statistics further suggest that with a combination of a seat belt and an airbag, serious chest injuries in frontal collisions can be reduced by 65% and serious head injuries by up to 75%. Airbag use presents clear benefits, and vehicle owners are frequently willing to pay the added expense for airbags. In addition, the inclusion of inflatable safety restraint devices, or airbags, is now a legal requirement for many new vehicles.

Airbag systems typically include three principal components: an electronic control unit (ECU), an inflator, and an inflatable cushion. The ECU monitors the acceleration and deceleration of the vehicle and determines when accident conditions exist. The ECU is in communication with the inflator and transmits a signal to the inflator when the ECU determines that the vehicle has been involved in an accident.

In response to receipt of the signal, the inflator generates inflation gas. The inflator can be designed to produce inflation gas using various methods. For instance, the inflator may use pyrotechnic techniques or simply release compressed gas. In addition, the inflator may use a combination of both pyrotechnics and compressed gas to produce pressurized inflation gas. The inflator is in fluid communication with the inflatable cushion.

Prior to deployment, the inflatable cushion is housed within an airbag cover. The cover both protects the inflatable cushion from damage and provides a cosmetic cover to the cushion. When the inflatable cushion receives the gas generated by the inflator, the cushion expands. In response to expansion of the cushion, the cover opens to permit the cushion to fully deploy.

Thus, a key aspect of an airbag system is the cover. The cover includes tear seams that open in response to expansion of the contained cushion. The tear seams can affect the direction and sequence of deployment of the cushion.

In addition, the durability and appearance of an airbag cover is very important. Airbag covers, in addition to the functional requirements that enable proper deployment of the cushion, must conform to the overall aesthetic scheme of the interior of the vehicle.

Originally, airbag covers were painted to achieve a desired exterior color. Unfortunately, painting airbag covers is labor-intensive and is expensive. The time required to cure the paint creates yet another delay in the manufacturing process. Also, if multi-color covers are required the labor and expense are also increased. Furthermore, environmental conditions must be carefully controlled to ensure the desired durability, texture, and color of the applied coat of paint. Most painted covers have good scratch and mar resistance. However, the added cost of paint, adhesion promoter, and associated processing make this method very expensive.

Other airbag covers are made with “no-paint” materials. This type of airbag cover involves the addition of a coloring agent to the raw materials from which the cover is formed either before or during the molding process. The raw materials for these covers can be more expensive than standard, paintable materials, but overall they offer a cost savings because they eliminate the cost and processing associated with painting. Unfortunately, each cover must be specially manufactured to conform to the specific aesthetic scheme of a particular vehicle. Airbag covers of a specific color must be ordered and manufactured to coordinate the cover with the upholstery, dashboard, and interior of the vehicle. Matching the colors of the airbag cover to surrounding areas of the dashboard can be difficult because the airbag covers must be made from a material that has higher engineering requirements than other areas of the dashboard. Moreover, the color of the cover cannot be modified once the molding process is completed. In addition, no-paint airbag covers are more susceptible to marring and scratching than painted airbag covers.

To address the foregoing problems, airbag covers using an applique film have been developed. The applique film is a thin sheet on which a color or design may be printed. The applique film is then attached to the underlying cover, possibly during the molding process of the cover.

Unfortunately, conventional applique film airbag covers suffer from a critical limitation. It has long been believed in the industry that placement of an applique film over a tear seam in the cover would interfere with deployment of the cushion and proper tearing of the cover. As a result, these types of conventional covers place applique film on all areas of the underlying cover except on or across the tear seams. Consequently, considerable expense is required to design and manufacture applique films that do not traverse the tear seams in the cover. The applique film must be cut and precisely fitted on the cover to avoid traversing the tear seams. This process is time-consuming and expensive. Furthermore, if the applique film is not applied with precision to the cover, unsightly gaps or overlaps of the applique film will result.

Another problem related to airbag covers involves the attachment of separate and discrete emblems to the exterior surface of the cover. These emblems, which generally comprise the logo of an automobile manufacturer, are often positioned in the center of the steering wheel on top of the driver's side airbag cover. Unfortunately, these emblems are frequently made from rigid materials, such as aluminum or hard plastic. Thus, these emblems add mass to the cover and produce a stiff and inflexible region in the cover that must be accounted for in considering the deployment direction and sequence of the housed cushion. In addition, these emblems are frequently placed next to tear seams in the cover, which can adversely impact the deployment characteristics of the cover.

Accordingly, there is a need in the art for a novel airbag cover that addresses one or more of the above-listed problems. Such a cover is disclosed herein.

### SUMMARY OF THE INVENTION

The apparatus of the present invention has been developed in response to the present state of the art, and in particular, in response to problems and needs in the art that have not yet been fully solved by currently available airbag systems. The applique film airbag cover resolves these concerns in that a unitary applique film may be applied to the entire exposed surface of the cover and may be disposed on or across tear seams. Furthermore, the cover of the present invention may include an integrated three-dimensional emblem, which avoids the need for a separate and discrete emblem that can adversely impact the deployment characteristics of the cover.

The cover of the present invention is versatile and may be adapted to house cushions of various types. For example, the applique film cover may be designed to house, for example, a passenger-side airbag, a driver's side airbag, or a knee bolster inflatable cushion.

The applique film airbag cover includes an applique film and a substrate. The applique film may be made from various types of materials, such as polypropylene. The material used to make the applique film may be selected to achieve a desired softness, gloss, texture, color, mar resistance, and tensile or yield strength.

The applique film may be colored, transparent, or translucent. Various techniques, including silk screening and ink printing, may be used to place a design or color on the applique film. In one embodiment, an emblem design is printed on the applique film.

The applique film may comprise a single layer. Alternatively, the applique film may comprise a plurality or laminate of layers. For example, in one embodiment, the applique film comprises a colored layer surrounded by two outer protective layers. In one embodiment, one or both of the outer protective layers may be comprised of Santoprene®. The colored layer may include a solid color or a design, such as a simulated wood grain finish.

The applique film is disposed on an exposed surface of the substrate and is disposed across at least one tear seam in the substrate. In one embodiment, the applique film covers an entirety of the exposed surface. The applique film is frangible and ruptures in response to expansion of the cushion so that the cushion can deploy through the cover.

Various structural features of the present invention may be used to facilitate rupturing of the applique film. For instance, the applique film, in one embodiment, is 0.5 mm or less in thickness. Alternatively, the applique film may be up to 1.0 mm in thickness. Applique films of other thickness levels may be used within the scope of this invention so long as the applique film ruptures in response to expansion of the cushion. This may be achieved, for example, by using an applique film comprised of a material having a low tensile or yield strength.

In addition, to further facilitate rupturing of the applique film, the applique film may also include a tear seam. The tear seam is a weakened or narrowed region of the applique film. Various techniques, including scoring, perforations, and attaching separate pieces together, may be used to form the tear seam. The tear seam in the applique film may have various shapes to match the shape of the tear seam in the cover, such as an H-shape, or U-shape.

As stated above, the cover also includes a substrate. The substrate covers or encloses the cushion when the cushion is in a stowed condition. As will be recognized by those of skill in the art, the cover may be made of various materials, including styrenic-based polymers, thermoplastic elastomers, thermoplastic polyolefins, or other types of thermoplastics.

The substrate has an exposed surface. The exposed surface is that portion of the substrate that is exposed when the cover is installed in a vehicle. The exposed surface of the substrate will be visible in the passenger compartment of a vehicle if not obscured by the applique film.

In some embodiments, the exposed surface includes contours. The contours correspond to an emblem design on the applique film. When the applique film is applied to the exposed surface and the emblem design is aligned with the contours, the emblem design and applique film combine to produce a three-dimensional emblem, which may be a vehicle manufacturer's logo. Accordingly, the need for a separate three-dimensional emblem is obviated.

At least one tear seam is disposed in the exposed surface. The tear seam ruptures in response to expansion of the inflatable cushion to permit the inflatable cushion to deploy through the substrate. As with the tear seam in the applique film, various techniques, such as scoring, may be used to form the tear seam in the exposed surface. Also, the tear seam in the exposed surface may likewise have various shapes, such as an H-shape.

The substrate may also include one or more hinged flaps. The hinged flaps may have a number of different shapes, such as a square, rounded, or nonsymmetrical shape. The hinged flap is bounded by a single hinge and one or more tear seams. Those skilled in the art will recognize that the hinge may be embodied in a number of different ways. For example, the hinge may simply be a weakened region of the substrate that permits rotation of the flap, while securely retaining the flap to the remainder of the substrate.

In response to expansion of the cushion, the tear seams surrounding the hinged flap rupture, each hinged flap rotates about the attached hinge and applies pressure to the applique film. The rotation of the hinged flap and expansion of the cushion cause the applique film to rupture, thus permitting the cushion to emerge through an opening created by displacement of the hinged flap.

The applique film airbag cover thus provides substantial advantages over conventional covers. A unitary applique film may be applied to the entire exposed surface of the substrate, even across tear seams in the substrate. Thus, there is no need to precisely cut and fit an applique film to avoid traversing the tear seams. Unsightly gaps and overlaps are avoided. In addition, the applique film airbag cover may have an integrated three-dimensional emblem, which obviates the need for a separate and discrete emblem.

These and other features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and features of the invention are obtained, a more particular description of the invention summarized above will be rendered by reference to the appended drawings. Understanding that these drawings illustrate only selected embodiments of the invention and are not therefore to be considered limiting in scope, the invention will be described and explained with additional specificity and detail through the use of the accompanying drawings in which:

FIG. 1 is an exploded view of an airbag cover of the present invention shown with an inflatable cushion disposed therein;

FIG. 2 is a partial cross-sectional view of the airbag cover of the present invention illustrated with an inflatable cushion and an inflator;

FIG. 3 is a partial cross-sectional view of an alternative embodiment of the airbag cover shown with an inflatable cushion and an inflator;

FIG. 4 is a perspective view of the airbag cover of the present invention installed in a vehicle; and

FIG. 5 is a perspective view of the airbag cover of the present invention during deployment of the inflatable cushion.

### DETAILED DESCRIPTION OF THE PREFERRED EMBODIMENTS

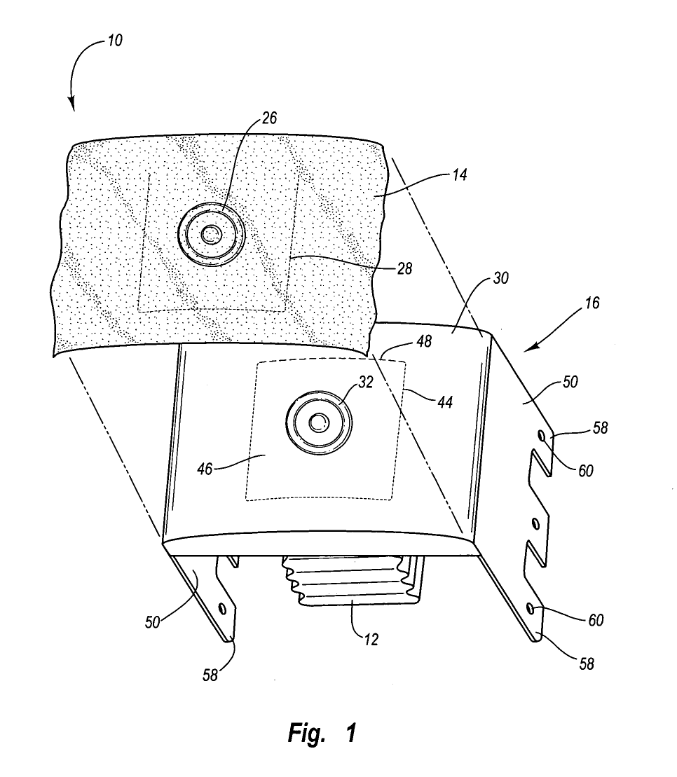

The preferred embodiments of the invention are now described with reference to FIGS. 1-5, wherein like parts are designated by like numerals throughout. The members of the present invention, as generally described and illustrated in the Figures, may be designed in a wide variety of configurations. Thus, the following more detailed description of the embodiments of the present invention, as represented in the Figures, is not intended to limit the scope of the invention, as claimed, but is merely representative of presently preferred embodiments of the invention.

In this application, the phrases “connected to,” “coupled to,” and “in communication with” refer to any form of interaction between two or more entities, including chemical, mechanical, electrical, magnetic, electromagnetic, electromechanical and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “directly attached to” refers to a form of attachment by which the attached items are either in direct contact, or are only separated by a single connector, adhesive, or other attachment mechanism. The term “abutting” refers to items that are in direct physical contact with each other, although the items may not be attached together.

FIG. 1 is an exploded view of an airbag cover 10 of the present invention shown with an inflatable cushion 12 disposed therein. The cover 10 of the present invention includes an applique film 14 disposed on a substrate 16. In the exploded view of FIG. 1 the applique film 14 is shown separated from the substrate 16.

The illustrated cover 10 is designed to house a passenger-side cushion 12. However, it should be noted that the cover 10 of the present invention may be embodied in various designs and sizes to house, for example, a driver's side airbag or a knee bolster airbag.

The applique film 14 of FIG. 1 is rectangular in shape and is thus adapted to be disposed on the depicted substrate 16. However, the applique film 14 may have other shapes, such as a round, square, or non-symmetrical shape.

In addition, the applique film 14 may be made from various types of materials, such as polypropylene or polyethylene. The material used to make the applique film 14 may be selected to achieve a desired softness, gloss, texture, color, mar resistance, and tensile or yield strength.

The applique film 14 may be colored or at least substantially transparent, i.e., transparent or translucent. A unitary color or a design, such as a simulated wood grain finish, can be printed on the applique film 14.

As illustrated in FIG. 1, an emblem design 26 can optionally be printed on the applique film 14. The emblem design 26 could be, for example, a logo of the manufacturer of a vehicle (not shown) in which the cover 10 will be installed. Various techniques, including silk screening and ink printing, may be used to place a design or color on the applique film 14.

The applique film 14 is frangible and thus ruptures in response to expansion of the cushion 12. Various structural features of the present invention may be used to facilitate rupturing of the applique film 14. For instance, the applique film 14, in one embodiment, is 0.3, 0.4, or 0.5 mm or less in thickness. Applique films 14 of other thickness levels may be used within the scope of this invention so long as the applique film 14 ruptures in response to expansion of the cushion 12. This may be achieved, for example, by using an applique film 14 comprised of a material having a lower tensile or yield strength.

In addition, to further facilitate rupturing of the applique film 14, the applique film 14 may include a tear seam 28. The tear seam 28 is a weakened or narrowed region of the applique film 14. Various techniques, including scoring, perforations, attaching separate pieces together, may be used to form the tear seam 28. The illustrated tear seam 28 generally has a U-shape. Alternatively, the tear seam 28 may have other shapes, such as an H-shape.

As stated above, the cover 10 also includes a substrate 16. The substrate 16 covers or encloses the cushion 12 when the cushion 12 is in a stowed condition, as shown in FIG. 1. As will be recognized by those of skill in the art, the cover 10 may be made of various materials, including styrenic-based polymers, thermoplastic elastomers, thermoplastic polyolefins, or other types of thermoplastics. The substrate 12 may be formed during an injection molding process and thus may comprise an injected material.

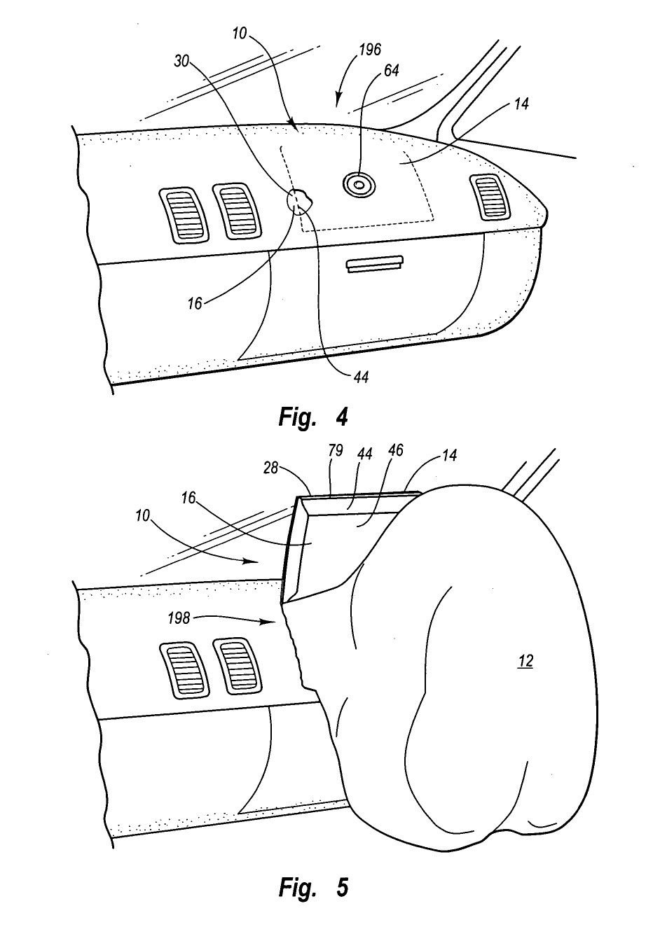

The substrate 16 has an exposed surface 30. The exposed surface 30 is that portion of the substrate that is exposed when the cover 10 is installed in a vehicle, as illustrated in FIG. 4.

With reference to FIG. 1, the exposed surface of the substrate 16 includes contours 32 that correspond to the emblem design 26 on the applique film 14. When the applique film 14 is disposed on the exposed surface 30, the contours 32 and emblem design 26 combine to produce a three-dimensional emblem.

At least one tear seam 44 is disposed in the exposed surface 30. The tear seam 44 ruptures in response to expansion of the inflatable cushion to permit the inflatable cushion to deploy through the substrate 16. In one embodiment, the tear seam 44 is 0.5 to 0.7 mm in thickness. Of course, tear seams 44 of other thickness levels may be used within the scope of this invention. As with the tear seam 28 in the applique film 14, various techniques, such as scoring, may be used to form the tear seam 44 in the exposed surface 30. In addition, the tear seam 44 may be formed during the molding process. Also, the tear seam 44 in the exposed surface 30 may likewise have various shapes, such as an H-shape.

The substrate 16 may also include a hinged door or flap 46. As illustrated, the hinged flap 46 is rectangular and is bounded on three sides by the tear seam 44. The remaining side of the hinged flap 46 is attached to a hinge 48. During deployment of the cushion 12, the tear seam 44 ruptures and the hinged flap 46 rotates relative to the hinge 48.

The hinged flap 46 may have a number of different shapes, such as a square, rounded, or non-symmetrical shape. Also, those skilled in the art will recognize that the hinge 48 may be embodied in a number of different ways. For example, the hinge 48 may simply be a weakened region of the substrate 16 that permits rotation of the hinged flap 46, while securely retaining the flap 46 to the remainder of the substrate 16.

When the applique film 14 is secured to the substrate 16, the applique film 14 is disposed on the exposed surface 30 and across the tear seam 44. In one embodiment, the applique film 14 covers an entirety of the exposed surface 30.

The substrate 16 may also include attachment walls or brackets 50. The attachment brackets 50 may include extensions 58 having openings 60 for receiving a securing mechanism (not shown), such as a bolt or rivet, to secure the cover 10 to a vehicle (not shown). Those skilled in the art will recognize that attachment brackets 50 of varying types or other types of attachment mechanisms may be used within the scope of this invention.

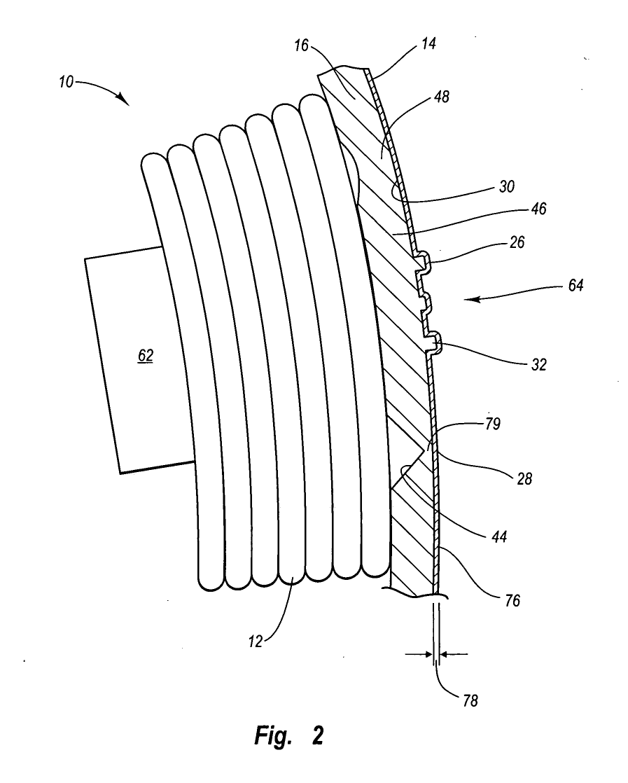

FIG. 2 is a partial cross-sectional view of the airbag cover 10 of the present invention shown with an inflatable cushion 12 disposed within the cover 10. An inflator 62, which is in fluid communication with the cushion 12, is also illustrated. As stated above, the cover 10 includes a substrate 16 and an applique film 14.

FIG. 2 shows a cross-sectional view of the hinge 48 and tear seam 44 of the substrate 16. The hinged flap 46 is disposed between the hinge 48 and tear seam 44. As explained, the substrate 16 also includes contours 32 that may be aligned with the emblem design 26 on the applique film 14 to produce a three-dimensional emblem 64, such as a vehicle manufacturer's logo.

As shown, the applique film 14 is disposed on the exposed surface 30 of the substrate 16 and is disposed across the tear seam 44 in the substrate 16. The applique film 14 is secured to the exposed surface 30 using various techniques known to those of skill in the art, such as adhesives, rivets, ultrasonic welding, or chemical bonding. In one embodiment, the applique film 14 is bonded to the substrate 16 during the molding process of substrate 16.

The applique film 14 of FIG. 2 is formed from a single layer 76, as opposed to a laminate of layers. In one embodiment, the applique film 14 has a thickness 78 of 0.5 mm or less.

The applique film 14 of the present invention is unitary. This means that the applique film 14 may be formed from a single, integrally formed piece of material or from a plurality of pieces of material or layers attached together. In one embodiment (not illustrated), more than one unitary applique film 14 is attached to the substrate 16.

The tear seam 28 of the applique film 14 is positioned on and generally aligned with the tear seam 44 in the exposed surface 30. The expansion of the inflatable cushion 12 applies pressure to the hinged flap 46 and the tear seam 44 of the substrate 16. The hinged flap 46 then applies pressure to the tear seam 28 of the applique film 14, causing the tear seam 28 of the applique film 14 to rupture.

In one embodiment, the tear seam 44 includes at least one narrow point 79, which is shown in its pre-deployment condition in FIG. 2. After the tear seam 44 ruptures in response to expansion of the cushion 12, the narrow point 79 (as shown in FIG. 5) applies focused pressure to and assists in rupturing the applique film 14.

Referring to FIG. 2, in an alternative embodiment, the applique film 14 does not include a tear seam 28. In such an embodiment, the applique film 14 is sufficiently thin or may have a sufficiently low tensile or yield strength such the applique film 14 ruptures in response to expansion of the cushion 12.

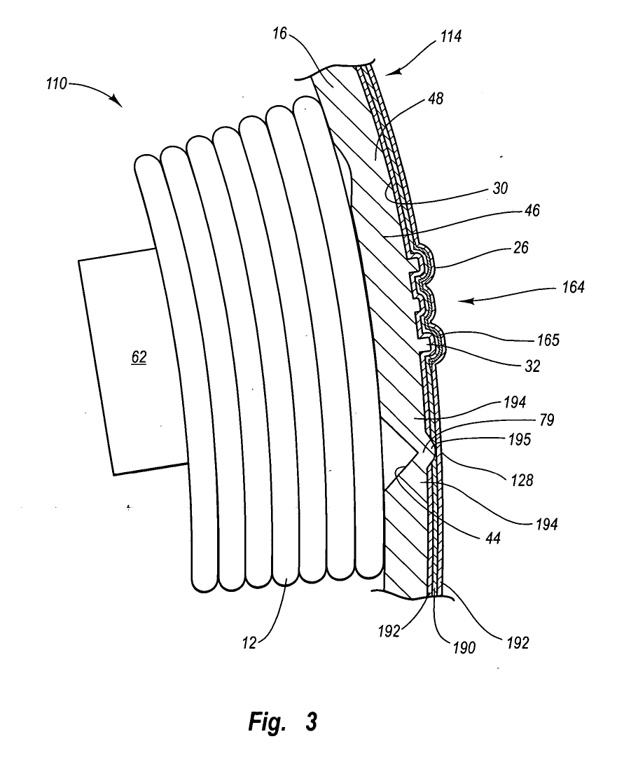

FIG. 3 is a partial cross-sectional view of an alternative embodiment of the airbag cover 110 shown with an inflatable cushion 12 and an inflator 62. The embodiment illustrated in FIG. 3 includes a substrate 16 and an applique film 114.

As with the embodiments shown in FIGS. 1 and 2, the substrate 16 of the present embodiment includes a hinge 48, tear seam 44, at least one narrow point 79, and a hinged flap 46 disposed between the hinge 48 and tear seam 44. The substrate 16 also includes contours 32 that correspond to the emblem design 26 on the applique film 114. A combination of the contours 32 and the aligned emblem design 26 produce a three-dimensional emblem 164.

Again, the applique film 114 is disposed on the exposed surface 30 of the substrate and is also disposed across the tear seam 44 in the exposed surface 30 of the substrate 16. As a result, the applique film 114 ruptures in response to expansion of the cushion 12.

The applique film 114 shown in FIG. 3 comprises a laminate of layers. In one embodiment, a colored layer 190 is disposed between two outer protective layers 192. The outer protective layers 192 prevent damage to or marring of the color layer 190. In one embodiment in which the applique film 114 comprises a laminate of layers, the applique film 114 is 1.0 mm or less in thickness.

The applique film 114 may also include a layer 193 that is disposed on select areas of the exposed surface 30. For example, such a layer 193 may be disposed only over the contours 32 to provide, for example, a different texture, gloss level, or color to the three-dimensional emblem 64. As a result, an applique film 114 may have varying thickness levels.

Applique films 114 having varying numbers and types of laminate layers come within the scope of this invention. For example, the applique film 114 of the present invention may comprise a colored layer 190 and a single outer protective layer 192. Alternatively, the applique film 114 may have more than three layers.

In one embodiment, the applique film 114 may include a tear seam 128. As illustrated, the tear seam 128 is generally aligned with the tear seam 44 in the exposed surface 30 of the substrate 16. The tear seam 128 ruptures in response to expansion of the cushion 12 and the opening of the hinged flap 46.

In one embodiment, the substrate 16 is at least 2.5 mm thick at a position 194 adjacent to the tear seam 44. In an alternative embodiment, the substrate 16 is from 3.0 to 4.0 mm thick at a position 194 adjacent to the tear seam 44. The thickness of the substrate 16 adjacent to the tear seam 44 decreases the possibility that the applique film 114 will tear or rip outside of the tear seam 44.

In addition or in the alternative to a narrow point 79, the substrate 16 may also include a local peak 195. The local peak 195 also facilitates rupturing of the applique film 114 by applying focused pressure to the applique film 114 during expansion of the cushion 12.

FIG. 4 is a perspective view of the airbag cover 10 of the present invention installed in a vehicle 196. It should be noted that the cover 110 of FIG. 3 can be also installed in a vehicle 196 in a manner similar to the cover 10 shown in FIG. 4.

In FIG. 4, a portion of the applique film 14 is cutaway to reveal the exposed surface 30 of the substrate 16 and the tear seam 44 in the substrate 16. The three-dimensional emblem 64 is exposed and visible to passengers of the vehicle 196.

The cover 10 is shown prior to deployment of the cushion 12 (shown in FIG. 5). As illustrated, the cover 10 is installed in the passenger-side of the vehicle 196. In alternative embodiments, the cover 10 may be designed to house a driver's side airbag or a knee bolster cushion (not shown).

The applique film 14 is disposed on the exposed surface 30 of the substrate 16 and is disposed across the tear seam 44. In the illustrated embodiment, the applique film 14 is disposed on and covers an entirety of the exposed surface 30 of the substrate 16.

FIG. 5 is a perspective view of the airbag cover 10 of the present invention shown during deployment of the inflatable cushion 12. As shown, the cushion 12 is fully or nearly fully inflated. The inflation of the cushion 12 has applied pressure to the hinged flap 46, rupturing the tear seams 28, 44 of both the substrate 16 and applique film 14. The narrow point 79 of the substrate 16 facilitated rupturing of the applique film 14. The cushion 12 has emerged through the opening 198 created by the displacement of the hinged flap 46.

The applique film airbag cover thus provides substantial advantages over conventional covers. A unitary applique film may be applied to the entire exposed surface of the substrate, even across tear seams in the substrate. Thus, there is no need to precisely cut and fit an applique film to avoid traversing the tear seams. Unsightly gaps and overlaps are avoided. In addition, the applique film airbag cover may have an integrated three-dimensional emblem, which obviates the need for a separate and discrete emblem.

The present invention may be embodied in other specific forms without departing from its structures, methods, or other essential characteristics as broadly described herein and claimed hereinafter. The described embodiments are to be considered in all respects as only illustrative, and not restrictive. The scope of the invention is, therefore, indicated by the appended claims, rather than by the foregoing description. All changes that come within the meaning and range of equivalency of the claims are to be embraced within their scope.

1. An airbag cover, comprising:
a substrate having an exposed surface;
at least one tear seam disposed in the exposed surface; and
a unitary applique film that is disposed on the exposed surface and is disposed across the tear seam, wherein the tear seam and applique film are frangible and rupture in response to expansion of an inflatable cushion to permit the cushion to deploy through the substrate and applique film.

2. The airbag cover of claim 1, wherein the applique film comprises a laminate of layers.

3. The airbag cover of claim 2, wherein the applique film comprises a colored layer and an outer layer.

4. The airbag cover of claim 2, wherein the applique film comprises a layer that is disposed on select areas of the exposed surface.

5. The airbag cover of claim 1, wherein the applique film comprises a single layer.

6. The airbag cover of claim 1, wherein the applique film has a thickness no greater than 0.5 mm.

7. The airbag cover of claim 1, wherein the applique film has a thickness no greater than 1.0 mm.

8. The airbag cover of claim 1, wherein the substrate has a narrow point that facilitates rupturing of the applique film.

9. The airbag cover of claim 1, wherein the substrate has a local peak that facilitates rupturing of the applique film.

10. The airbag cover of claim 1, wherein the substrate is at least 2.5 mm thick adjacent to the tear seam.

11. The airbag cover of claim 1, wherein the substrate comprises a hinged flap.

12. The airbag cover of claim 1, wherein the applique film comprises a tear seam.

13. The airbag cover of claim 12, wherein the tear seam of the applique film is generally aligned with the tear seam in the exposed surface.

14. The airbag cover of claim 1, wherein the applique film is at least substantially transparent.

15. The airbag cover of claim 1, wherein the substrate comprises an injected material.

16. An airbag cover, comprising:
a substrate having an exposed surface;
at least one tear seam in the exposed surface; and
a unitary applique film that is disposed on the exposed surface and is disposed across the tear seam, wherein the tear seam and applique film are frangible and rupture in response to expansion of an inflatable cushion to permit the cushion to deploy through the substrate and applique film, and wherein the applique film includes an emblem design aligned with corresponding contours in the substrate to produce a three-dimensional emblem.

17. The airbag cover of claim 16, wherein the applique film comprises a laminate of layers.

18. The airbag cover of claim 17, wherein the applique film comprises a colored layer and an outer layer.

19. The airbag cover of claim 17, wherein the applique film comprises a layer that is disposed on select areas of the exposed surface.

20. The airbag cover of claim 16, wherein the applique film comprises a single layer.

21. The airbag cover of claim 16, wherein the applique film has a thickness no greater than 0.5 mm.

22. The airbag cover of claim 16, wherein the substrate has a narrow point that facilitates rupturing of the applique film.

23. The airbag cover of claim 16, wherein the substrate has a local peak that facilitates rupturing of the applique film.

24. The airbag cover of claim 16, wherein the substrate is at least 2.5 mm thick adjacent to the tear seam.

25. The airbag cover of claim 16, wherein the substrate comprises a hinged flap.

26. The airbag cover of claim 16, wherein the applique film comprises a tear seam.

27. The airbag cover of claim 26, wherein the tear seam of the applique film is generally aligned with the tear seam in the exposed surface.

28. The airbag cover of claim 16, wherein the three-dimensional emblem is a vehicle manufacturer's logo.

29. The airbag cover of claim 16, wherein the applique film is at least substantially transparent.

30. The airbag cover of claim 16, wherein the substrate comprises an injected material.

31. An airbag cover, comprising:
a substrate having an exposed surface;
at least one tear seam in the exposed surface; and
a unitary applique film that is disposed on and covers an entirety of the exposed surface and is disposed across at least one tear seam, wherein each tear seam and the applique film are frangible and rupture in response to expansion of an inflatable cushion to permit the cushion to deploy through the substrate and applique film.

32. The airbag cover of claim 31, wherein the applique film comprises a laminate of layers.

33. The airbag cover of claim 32, wherein the applique film comprises a layer that is disposed on select areas of the exposed surface.

34. The airbag cover of claim 31, wherein the applique film comprises a single layer.

35. The airbag cover of claim 31, wherein the substrate comprises a hinged flap.

36. The airbag cover of claim 31, wherein the applique film has a thickness no greater than 0.5 mm.

37. The airbag cover of claim 31, wherein the applique film has a thickness no greater than 1.0 mm.

38. The airbag cover of claim 31, wherein the substrate has a narrow point that facilitates rupturing of the applique film.

39. The airbag cover of claim 31, wherein the substrate has a local peak that facilitates rupturing of the applique film.

40. The airbag cover of claim 31, wherein the substrate is at least 2.5 mm thick adjacent to the tear seam.

41. The airbag cover of claim 31, wherein the applique film comprises a tear seam generally aligned with the tear seam in the exposed surface.

42. The airbag cover of claim 31, wherein the substrate comprises an injected material.

43. An airbag cover, comprising:
substrate means for concealing an inflatable cushion, the substrate means having an exposed surface;
tear seam means in the exposed surface that enables the cushion to emerge through the substrate during inflation of the cushion; and
unitary applique film means that provides a cosmetic cover for the substrate, wherein the applique film means is disposed on the exposed surface and is disposed across the tear seam means, wherein the tear seam means and applique film means are frangible and rupture in response to expansion of the cushion to permit the cushion to deploy through the substrate means and applique film means.
